(19) United States
(12) Patent Application Publication
(10) Pub. No.: US 2009/0225291 A1
(43) Pub. Date: Sep. 10, 2009

(54) EXPOSURE APPARATUS, EXPOSURE METHOD, AND DEVICE MANUFACTURING METHOD

(75) Inventors: Sunao Mori, Utsunomiya-shi (JP); Keita Sakai, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/400,946

(22) Filed: Mar. 10, 2009

(30) Foreign Application Priority Data
Mar. 10, 2008 (JP) 2008-059496

(51) Int. Cl. G03B 27/52; G03B 27/32

(52) U.S. Cl. 355/30; 355/77

(57) ABSTRACT

An exposure apparatus exposes a substrate to exposure light via an organic liquid. The exposure apparatus includes an oxidation reaction device and a filter. The oxidation reaction device generates oxide by causing reaction between the organic liquid and at least one of oxygen and water in the organic liquid through the application of illumination light onto the organic liquid. The filter removes the oxide generated by the oxidation reaction device from the organic liquid. The organic liquid is supplied onto the substrate via the oxidation reaction device and the filter.

### BACKGROUND OF THE INVENTION

1. Field of the Invention

The present invention relates to an exposure apparatus, an exposure method, and a device manufacturing method in which a substrate is exposed to exposure light via organic liquid.

2. Description of the Related Art

With recent increase in integration density of semiconductor devices, there is a demand for higher performance of semiconductor exposure apparatuses.

As high-performance semiconductor exposure apparatuses, immersion exposure apparatuses have been developed. In an immersion exposure apparatus, a wafer is exposed in a state in which a space between the wafer and the final lens of a projection optical system closest to the wafer is filled with immersion liquid. With this structure, the wavelength of exposure light is apparently 1/n in immersion liquid having a refractive index n, and therefore, the resolving power of the exposure apparatus can be increased. Moreover, the focal depth can be multiplied by n.

Immersion exposure apparatuses using ultra pure water as immersion liquid have now been developed. In these immersion exposure apparatuses, it is necessary to use ultra pure water that does not contain any organic materials and bacteria. Accordingly, Japanese Patent Laid-Open No. 2005-079584 proposes an immersion exposure apparatus including a purifier that removes organic materials and bacteria from ultra pure water.

The performance of the immersion exposure apparatus increases as the refractive index of immersion liquid increases. A high-refractive-index-liquid immersion exposure apparatus proposed in Japanese Patent Laid-Open No. 2007-180450 uses, as immersion liquid, a high-refractive-index liquid having a refractive index higher than that of ultra pure water (liquid having a refractive index more than 1.5 for exposure light).

Oxygen more easily dissolves into an organic liquid than ultra pure water. When oxygen in the air dissolves into an organic liquid, the transmittance of the organic liquid decreases significantly. For this reason, the immersion exposure apparatus using an organic liquid as immersion liquid has a problem in that the transmittance of the immersion liquid easily decreases.

Organic liquid is supplied in a refined state into the immersion exposure apparatus. Unfortunately, even though the organic liquid is refined, that does not mean that the organic liquid contains no water. When an organic liquid containing a small amount of water is irradiated with exposure light, reaction, such as oxidation and decomposition, occurs in the organic liquid. With the reaction, the transmittance of the organic liquid itself serving as the immersion liquid decreases, and the transmittance of the projection optical system is lowered because matters produced by reaction, such as oxidation and decomposition, are attached to the final lens of the projection optical system. This may reduce performance of the exposure apparatus.

### SUMMARY OF THE INVENTION

The present invention provides an immersion exposure apparatus that can reliably remove oxygen or water from immersion liquid formed by an organic liquid.

Accordingly, an immersion exposure apparatus according to an aspect of the present invention exposes a substrate to exposure light via an organic liquid. The exposure apparatus includes an oxidation reaction device configured to generate oxide by causing reaction between the organic liquid and at least one of oxygen and water in the organic liquid through the application of illumination light onto the organic liquid; and a filter configured to remove the oxide generated by the oxidation reaction device from the organic liquid. The organic liquid is supplied onto the substrate via the oxidation reaction device and the filter.

Further features of the present invention will become apparent from the following description of exemplary embodiments with reference to the attached drawings.

### BRIEF DESCRIPTION OF THE DRAWINGS

FIG. 1 shows an immersion exposure apparatus according to a first embodiment of the present invention.

FIG. 2 shows an immersion exposure apparatus according to a second embodiment of the present invention.

FIG. 3 is a detailed view illustrating a circulation path in the immersion exposure apparatus of the second embodiment.

FIG. 4 is a graph showing changes in oxygen concentration in an immersion liquid supplied to an immersion region.

FIG. 5 shows an oxidation reaction device in the immersion exposure apparatus of the first embodiment.

FIG. 6 shows an oxidation reaction device in an immersion exposure apparatus according to a third embodiment of the present invention.

### DESCRIPTION OF THE EMBODIMENTS

Immersion exposure apparatuses according to various exemplary embodiments of the present invention will now be described with reference to the drawings. For concise explanation, the same members are denoted by the same reference numerals through the drawings.

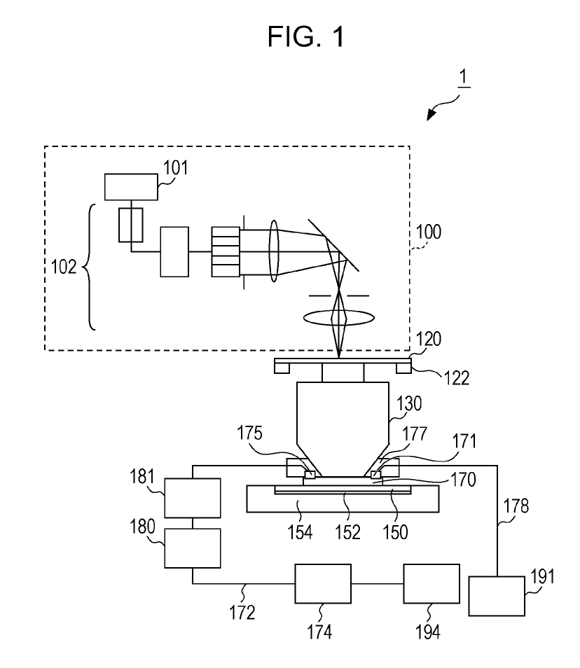

FIG. 1 shows an immersion exposure apparatus 1 according to a first embodiment of the present invention. Referring to FIG. 1, the immersion exposure apparatus 1 includes an illumination device 100, a reticle stage 122, a projection optical system 130, a wafer stage 154, and a nozzle unit 177. As the immersion exposure apparatus 1, a step-and-scan exposure apparatus or a step-and-repeat exposure apparatus can be used.

The illumination device 100 includes an exposure light source 101, and an illumination optical system 102 that illuminates a reticle 120 held on the reticle stage 122 with exposure light from the exposure light source 101. As the exposure light source 101, for example, an ArF excimer laser with a wavelength of 193 nm or an F2 laser with a wavelength of 157 nm can be used.

The reticle stage 122 moves while holding the reticle 120. The reticle is an original, and is also called a photomask.

The projection optical system 130 projects a pattern provided on the reticle 120 onto a wafer 150 via immersion liquid 170. The immersion liquid 170 is filled between the wafer 150 and the final lens of the projection optical system 130 closest to the wafer 150. A liquid film of the immersion liquid 170 does not cover the entire surface of the wafer 150, but covers only an immersion region provided on a part of the surface. In other words, the immersion exposure apparatus 1 adopts a so-called local fill method.

The wafer stage 154 moves while holding the wafer 150 via a wafer chuck 152. While the wafer is used as a substrate in the first embodiment, for example, a glass plate can be used as the substrate. The wafer 150 is coated with a resist serving as a photosensitive material.

The nozzle unit 177 includes a supply nozzle 175 and a recovery nozzle 171. The nozzle unit 177 is provided around the final lens of the projection optical system 130. The immersion liquid 170 is supplied in a refined state from a supply liquid tank 194, and is supplied from the supply nozzle 175 to the immersion region on the wafer 150 via a supply path 172. The immersion liquid 170 supplied to the immersion region on the wafer 150 is recovered from the recovery nozzle 171 into a waste liquid tank 191 via a recovery path 178.

As the immersion liquid 170, an organic liquid that has a refractive index more than 1.5 for exposure light and a high transmittance to exposure light, and that matches the resist well can be used. For example, any of organic liquids, decalin, bicyclohexyl, and cyclohexane, can be used.

In the supply path 172, at least an oxidation reaction device 180 and a filter 181 are provided. The immersion liquid 170 is supplied onto the wafer 150 via the oxidation reaction device 180 and the filter 181. The oxidation reaction device 180 excites oxygen or water in the immersion liquid 170, and causes reaction between the oxygen or water and the immersion liquid 170 so as to generate oxide. The filter 181 serves as a refining filter that removes the oxide generated by the oxidation reaction device 180 from the immersion liquid 170. In the supply path 172 or the recovery path 178, a pump for causing the immersion liquid 170 to flow, a flow-rate controller for controlling the flow rate of the immersion liquid 170, and a temperature controller for adjusting the temperature of the immersion liquid 170 (e.g., a heater or a heat exchanger) are provided appropriately.

As shown in FIG. 1, a deoxygenation device 174 for reducing oxygen in the immersion liquid 170 can be provided between the supply liquid tank 194 and the oxidation reaction device 180. The deoxygenation device 174 serves to reduce the oxygen concentration in the immersion liquid 170 to be supplied to the oxygen reaction device 180. The deoxygenation device 174 includes a substitution unit for substituting oxygen in the immersion liquid 170 with gas (e.g., nitrogen) that does not absorb exposure light, and a degassing unit for reducing the substituted gas in the immersion liquid 170. The degassing unit includes a film and a vacuum pump.

The principles and structures of the oxidation reaction device 180 and the filter 181 will be described in detail below.

An oxidation reaction of an organic liquid can be caused by heating the organic liquid or irradiating the organic liquid with light. However, when the organic liquid is heated, a decomposition reaction or a polymerization reaction may occur. Moreover, there is a need to cool the heated organic liquid before supplying the organic liquid to the wafer. For this reason, an oxidation reaction is caused by irradiating the organic liquid with light in the first embodiment.

When oxygen or water is irradiated with light, excited oxygen, ozone, or an OH radical that is highly oxidative is generated, as expressed by the following chemical reaction formulas (1) to (4), so that the organic liquid is oxidized:

O₂+light→O+O (1)

O₂+O→O₃ (2)

O₃+light→O(1D)+O₂ (3)

H₂O+O(1D)<2OH (4)

To efficiently promote the reaction, for example, ultraviolet rays having a wavelength less than 300 nm may be used as light. As a light source of the oxidation reaction device 180, for example, a low-pressure mercury lamp, a D2 lamp, or an excimer lamp can be used. In particular, a low-pressure mercury lamp radiates ultraviolet rays having wavelengths of 185 nm and 254 nm, and can promote the reaction without using any catalyst.

Alternatively, light used as exposure light in the exposure apparatus, for example, ultraviolet rays having wavelengths of 193 nm and 157 nm can be used. In this case, part of the exposure light from the exposure light source can be separated by an optical fiber, and the exposure light source can be used as a light source of the oxidation reaction device 180.

To efficiently generate an OH radical from the water in the organic liquid, TiO₂, for example, can be used as a catalyst.

By the excited oxygen, ozone, or OH radical, part of the organic liquid is oxidized so as to generate oxide having a COO group or a CO group. As a result, most of the oxygen and water in the organic liquid are consumed and lost, and the oxide is contained in the organic liquid.

Oxide having a COO group or a CO group is polarized. Therefore, when the filter 181 is formed of silica gel, zeolite, alumina, activated carbon, or a surface-modified hollow fiber, which adsorbs a polarized material, it can remove oxide from the organic liquid. In other words, it is possible to obtain an organic liquid that rarely contains oxygen, water, and oxide.

After passing through the filter 181, the organic liquid is supplied as an immersion liquid 170 from the supply nozzle 175. Consequently, the immersion liquid 170 (organic liquid) that rarely contains oxygen and water can be supplied to the immersion region under the final lens of the projection optical system 130. Therefore, absorption of the exposure light by the immersion liquid 170 is reduced. Moreover, since the immersion liquid 170 is irradiated with exposure light, it is hardly oxidized under the final lens. In other words, it is possible to minimize deterioration of the transmittance of the projection optical system 130 caused by oxide attached onto the surface of the final lens.

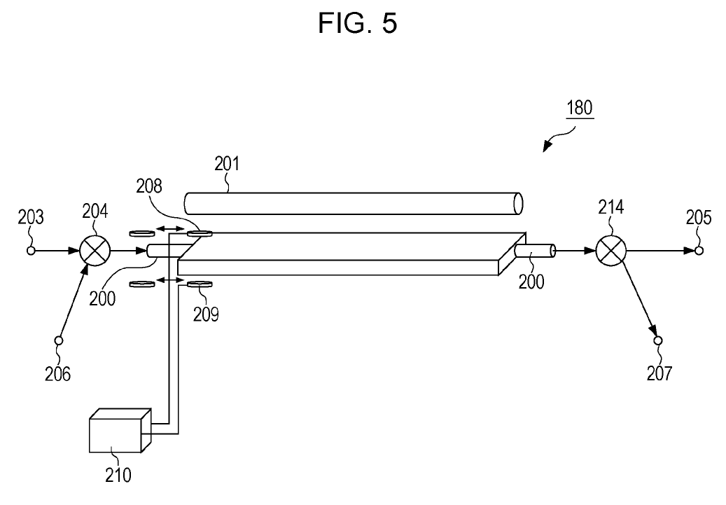

The structure of the oxidation reaction device 180 will now be described. FIG. 5 shows the oxidation reaction device 180 in the first embodiment. An inlet 203 of the oxidation reaction device 180 is a contact point through which the immersion liquid is introduced from the deoxygenation device 174. The immersion liquid from the inlet 203 flows through an oxidation reaction passage 200 via a passage switch valve 204. The oxidation reaction passage 200 is formed of a material that is transparent to illumination light. While flowing through the oxidation reaction passage 200, the immersion liquid is irradiated with ultraviolet rays serving as illumination light from a light source 201. The immersion liquid irradiated with the ultraviolet rays flows out from an outlet 205 via a passage switch valve 214, and is then guided to the filter 181.

When the use of the oxidation reaction device 180 is continued, oxide is attached and deposited on the inner wall of the oxidation reaction passage 200, and this soils the oxidation reaction passage 200. Hence, the oxidation reaction device 180 includes a transmittance measuring unit. The transmittance measuring unit includes illuminance sensors 208 and 209 and a calculation unit 210. The illuminance sensors 208 and 209 measure the amount of illumination light from the light source 201. First, the amount of illumination light from the light source 201 is measured with the illuminance sensor 208. The measured amount of light corresponds to the amount of illumination light incident on the oxidation reaction passage 200. Next, the illuminance sensor 208 is drawn out from between the oxidation reaction passage 200 and the light source 201, and the amount of light passing through the oxidation reaction passage 200, of the illumination light from the light source 201, is measured with the illuminance sensor 209. The calculation unit 210 divides the measured value of the illuminance sensor 209 by the measured value of the illuminance sensor 208, and thereby determines the transmittance of the oxidation reaction passage 200.

Periodically, the transmittance of the oxidation reaction passage 200 is measured with the transmittance measuring unit. At the time when the transmittance reaches a value that does not ensure a sufficient performance of the oxidation reaction device 180, exposure of the wafer 150 by the immersion exposure apparatus 1 is stopped, and supply of the immersion liquid from the supply liquid tank 194 is also stopped. In this case, gas for promoting oxidation is supplied into the oxidation reaction passage 200 from a gas supply port 206. The gas passing through the oxidation reaction passage 200 is discharged from a gas discharge port 207. In the first embodiment, clean air that does not contain any impurities is used as the gas for promoting oxidation. Alternatively, an inactive gas mixed with oxygen, ozone, or water can be used as the gas for promoting oxidation. By switching the passage by the passage switch valves 204 and 214, the clean air can be introduced into the oxidation reaction passage 200. Immediately after switching to the clean air is made, the interior of the oxidation reaction passage 200 is wet, and therefore, is dried. The drying time is checked beforehand, and the light source 201 is turned on when drying is completed. The oxide attached and deposited on the inner wall of the oxidation reaction passage 200 is further oxidized by the oxygen in the clean air and the illumination light, is thereby decomposed into carbon monoxide or carbon dioxide, and then is removed. The extent of removal can be determined by using the transmittance measuring unit.

As described above, since the immersion liquid 170 is supplied to the immersion region between the final lens and the wafer 150 via the oxidation reaction device 180 and the filter 181, the immersion exposure apparatus 1 of the first embodiment has high optical performance, and the performance does not easily deteriorate with time.

A variation of the first embodiment will now be described.

In an immersion exposure apparatus of this variation, an ArF excimer laser was used as the light source 101, bicyclohexyl having a refractive index of 1.64 was used as the immersion liquid 170, and a filter filled with silica gel was used as the filter 181.

Further, a low-pressure mercury lamp that mainly emits ultraviolet rays having wavelengths of 185 nm and 254 nm was used as the light source 201 in the oxidation reaction device 180, and a passage formed of synthetic quartz was used as the oxidation reaction passage 200.

The oxygen concentration in immersion liquid supplied from the supply nozzle 175 was measured with an oxygen concentration meter (InPro9800 from Mettler-Toledo International Inc.).

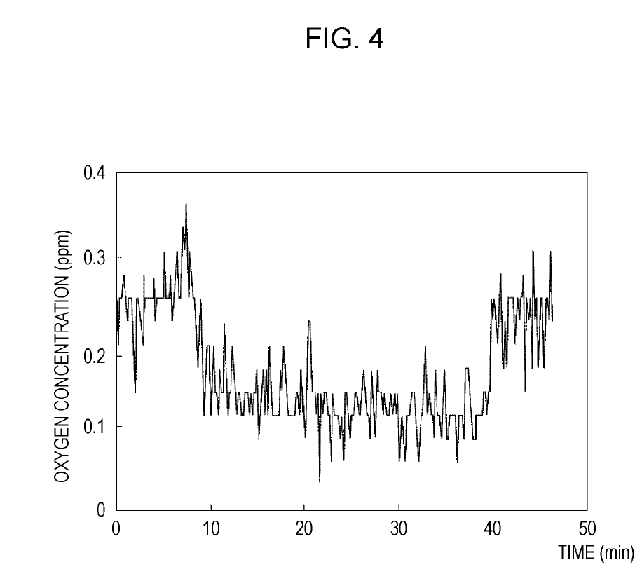

FIG. 4 is a graph showing changes in oxygen concentration in the immersion liquid supplied to the immersion region in a state in which the low-pressure mercury lamp serving as the light source 201 of the oxidation reaction device 180 was lit so as to apply ultraviolet rays to the immersion liquid. In FIG. 4, the vertical axis indicates the measured value of the oxygen concentration meter, and the horizontal axis indicates the elapsed time (minute). The low-pressure mercury lamp was lit during a period between an elapsed time of 10 minutes and an elapsed time of 40 minutes, and was not lit in other periods. While the oxygen concentration in the immersion liquid was 0.25 ppm in an OFF state of the low-pressure mercury lamp, it was 0.12 ppm in an ON state, which value was lower than the value in the OFF state. After the low-pressure mercury lamp was turned off, the oxygen concentration increased again and returned to 0.25 ppm. The above reveals that oxygen can be actually removed from the immersion liquid supplied to the immersion region by lighting the low-pressure mercury lamp.

In particular, a temporal change in optical performance (e.g., transmittance) of a projection optical system has been a significant problem for immersion exposure apparatuses of conventional design. When oxygen is contained in the immersion liquid, oxide of the organic liquid is attached onto the final lens, and this undesirably causes a temporal change in transmittance of the projection optical system.

As a comparative example, the wafer 150 was exposed in a state in which the low-pressure mercury lamp in the oxidation reaction device 180 was not lit. More specifically, a bare silicon wafer was placed as the wafer 150 on the wafer stage 154, and was exposed to exposure light from the exposure light source 101 while supplying the immersion liquid 170 between the bare silicon wafer and the final lens of the projection optical system 130. Exposure light was applied only by 10⁸ pls under the condition that the illuminance was 1.0 mJ/cm²/pls on the bare silicon wafer. The transmittance of the final lens of the projection optical system 130 was measured before and after irradiation with the exposure light. While the transmittance was 90.29% before irradiation, it was 85.78% after irradiation, that is, the transmittance deteriorated by about 4.5%.

Next, the bare silicon wafer was exposed under the same condition as above in a state in which the low-pressure mercury lamp in the oxidation reaction device 180 was lit. However, any change due to irradiation with exposure light was not found in the transmittance of the final lens.

The above reveals that temporal changes in the optical performance (e.g., transmittance) of the projection optical system can be reduced by lighting the low-pressure mercury lamp.

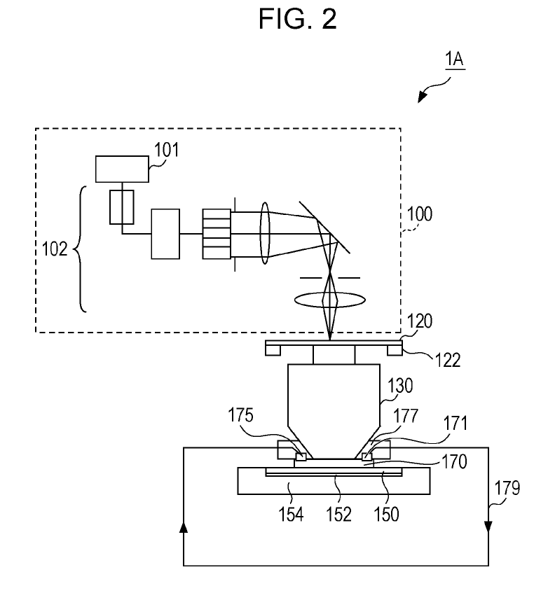

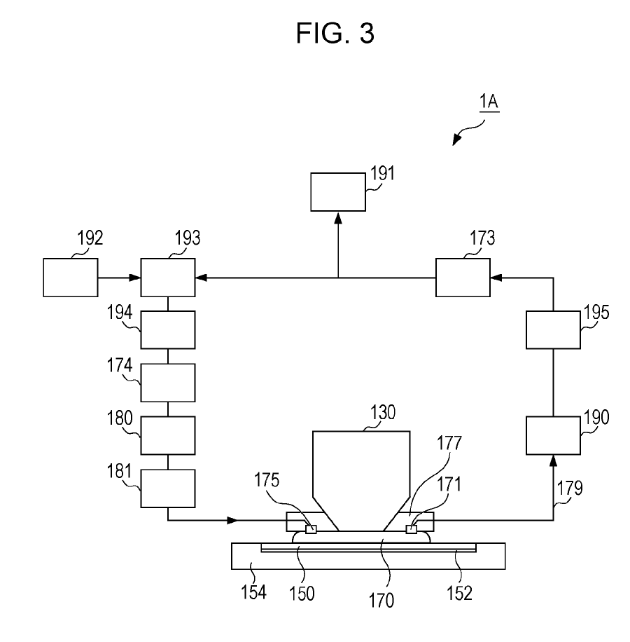

An immersion exposure apparatus according to a second embodiment will now be described with reference to FIGS. 2 and 3. Descriptions of components of the immersion exposure apparatus of the second embodiment that alike those of the immersion exposure apparatus of the first embodiment are omitted. FIGS. 2 and 3 show an immersion exposure apparatus 1A according to the second embodiment.

In the immersion exposure apparatus 1 of the first embodiment, all organic liquid recovered from the immersion region between the final lens and the wafer 150 is recovered into the waste liquid tank 191. In contrast, in the immersion exposure apparatus 1A of the second embodiment, organic liquid recovered from an immersion region between a final lens and a wafer 150 is supplied again to the immersion region so as to be reused. Since organic liquid used as the immersion liquid is more expensive than ultra pure water, the cost of manufacturing devices can be reduced by using the immersion exposure apparatus 1A of the second embodiment.

As shown in FIG. 2, in the immersion exposure apparatus 1A of the second embodiment, immersion liquid recovered by a recovery nozzle 171 is supplied from a supply nozzle 175 again to the immersion region via a circulation path 179.

FIG. 3 shows details of the circulation path 179. The immersion liquid recovered by the recovery nozzle 171 was guided to a transmittance meter 173 via a degassing unit 190 and a filter 195. The degassing unit 190 includes a film and a vacuum pump, and serves to reduce gas in the immersion liquid. The filter 195 is similar to a filter 181, and serves to remove oxide generated in the immersion liquid by irradiation with ultraviolet rays in the immersion region. The transmittance meter 173 serves to measure the transmittance of the immersion liquid. When the transmittance of the immersion liquid measured with the transmittance meter 173 exceeds an allowed value, the immersion liquid passing through the filter 195 is sent to a waste liquid tank 191. In contrast, when the measured transmittance is less than or equal to the allowed value, the immersion liquid passing through the filter 195 is sent to a mixing unit 193.

The immersion liquid passing through the filter 195 is supplied together with new immersion liquid from a new liquid tank 192 into a supply liquid tank 194 via the mixing unit 193. The immersion liquid from the supply liquid tank 194 is supplied to the immersion region via a deoxygenation device 174, an oxidation reaction device 180, a filter 181, and a supply nozzle 175.

As described above, in the immersion exposure apparatus 1A of the second embodiment, the immersion liquid recovered from the immersion region is supplied again to the immersion region between the final lens and the wafer 150 via the oxidation reaction device 180 and the filter 181. Therefore, the optical performance of the immersion exposure apparatus 1A is high, and is not easily deteriorated with time. Moreover, the cost of manufacturing devices can be reduced.

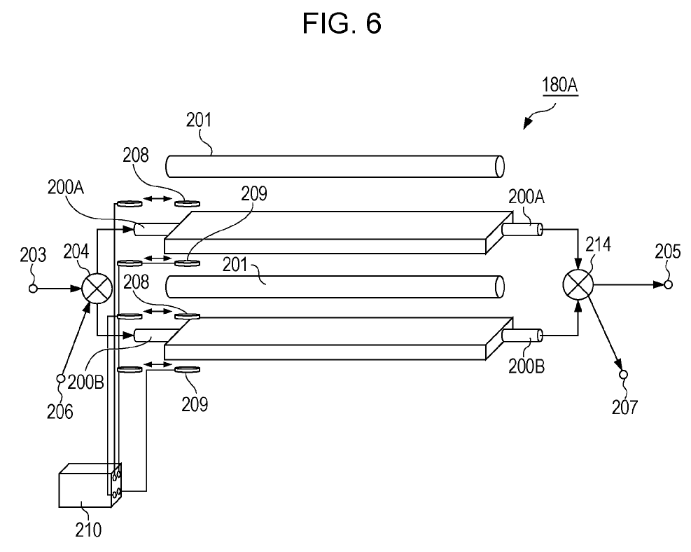

An immersion exposure apparatus according to a third embodiment will now be described with reference to FIG. 6. Descriptions of components of the immersion exposure apparatus of the third embodiment that are alike those of the immersion exposure apparatus of the second embodiment are omitted. FIG. 6 shows an oxidation reaction device 180A in the immersion exposure apparatus of the third embodiment.

The immersion exposure apparatus of the third embodiment adopts an oxidation reaction device 180A shown in FIG. 6 as an oxidation reaction device, instead of the oxidation reaction device 180 shown in FIG. 5. The oxidation reaction device 180A is characterized in having a plurality of oxidation reaction passages 200A and 200B. Near each oxidation reaction passage, a light source 201 and illuminance sensors 208 and 209 are provided. The light sources 201, the illuminance sensors 208 and 209, and a calculation unit 210 constitute a transmittance measuring unit. The oxidation reaction passages 200A and 200B are connected to passage switch valves 204 and 214. While the oxidation reaction device 180A shown in FIG. 6 includes two oxidation reaction passages, it can alternatively include three or more oxidation reaction passages.

In the immersion exposure apparatus of the third embodiment, first, immersion liquid (organic liquid) is supplied into only one of the two oxidation reaction passages, that is, the oxidation reaction passage 200A and is oxidized, and a wafer 150 is then exposed. When the use of the oxidation reaction passage 200A is continued, oxide in the immersion liquid is attached and deposited onto the inner wall of the passage. When the oxide is attached onto the inner wall of the passage, the amount of illumination light applied onto the immersion liquid flowing through the passage decreases. As a result, the ability of the oxidation reaction device decreases.

Accordingly, in the immersion exposure apparatus of the third embodiment, when the transmittance of the oxidation reaction passage 200A falls below an allowed value, the immersion liquid is not supplied into the oxidation reaction passage 200A, but is made to flow through the oxidation reaction passage 200B. In this state, oxidation is performed and the wafer 150 is exposed. While the immersion liquid is flowing through the oxidation reaction passage 200B, the oxidation reaction passage 200A is cleaned by irradiation with illumination light in a state in which clean air containing no impurities is supplied thereto.

When the transmittance of the oxidation reaction passage 200B falls below the allowed value, immersion liquid is made to flow through the oxidation reaction passage 200A, and the oxidation reaction passage 200B is cleaned.

As described above, in the emersion exposure apparatus of the third embodiment, the wafer 150 is exposed while switching the oxidation reaction passage through which the immersion liquid is made to flow. Therefore, it is unnecessary to stop exposure of the wafer 150 during cleaning of the oxidation reaction passage, and this achieves high throughput.

A manufacturing method for devices (e.g., semiconductor devices or liquid crystal display devices) will now be described. Here, a manufacturing method for semiconductor devices will be described as an example.

Semiconductor devices are manufactured through a front end process for forming integrated circuits on a wafer and a back end process for finishing integrated circuit chips formed on the wafer by the front end process into products. The front end process includes a step of exposing a wafer coated with a photosensitive material by using the above-described exposure apparatus, and a step of developing the wafer. The back end process includes an assembly process (dicing, bonding), and a packaging step (sealing).

According to the device manufacturing method of the fourth embodiment, it is possible to manufacture devices of higher quality than before.

While the present invention has been described with reference to various exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-059496 filed Mar. 10, 2008, which is hereby incorporated by reference herein in its entirety.

What is claimed is:

1. An exposure apparatus that exposes a substrate to exposure light via an organic liquid, the exposure apparatus comprising:
an oxidation reaction device configured to generate oxide by causing reaction between the organic liquid and at least one of oxygen and water in the organic liquid through the application of illumination light onto the organic liquid; and
a filter configured to remove the oxide generated by the oxidation reaction device from the organic liquid,
wherein the organic liquid is supplied onto the substrate via the oxidation reaction device and the filter.

2. The exposure apparatus according to claim 1, further comprising:
a deoxygenation device configured to reduce oxygen in the organic liquid supplied into the oxidation reaction device,
wherein the organic liquid is supplied onto the substrate via the deoxygenation device, the oxidation reaction device, and the filter.

3. The exposure apparatus according to claim 1, wherein the organic liquid exposed to the exposure light is recovered from the substrate, and is supplied onto the substrate again via the oxidation reaction device and the filter.

4. The exposure apparatus according to claim 1, wherein the oxidation reaction device includes a plurality of oxidation reaction passages through which the organic liquid is made to flow.

5. The exposure apparatus according to claim 4, wherein gas is made to flow through the plurality of oxidation reaction passages in the oxidation reaction device.

6. The exposure apparatus according to claim 1, wherein the oxidation reaction device includes:
an oxidation reaction passage; and
a transmittance measuring unit configured to measure a transmittance of the oxidation reaction passage to the illumination light.

7. The exposure apparatus according to claim 1, wherein a refractive index of the organic liquid for the exposure light is more than 1.5.

8. An exposure method that exposes a substrate to exposure light via an organic liquid, the exposure method comprising:
generating oxide by causing reaction between the organic liquid and at least one of oxygen and water in the organic liquid through the application of illumination light onto the organic liquid;
removing the oxide from the organic liquid;
supplying the organic liquid onto the substrate after the oxide is removed from the organic liquid; and
exposing the substrate to the exposure light via the organic liquid supplied onto the substrate.

9. A device manufacturing method comprising:
exposing a substrate with an exposure apparatus; and
developing the exposed substrate,
wherein the exposure apparatus exposes the substrate to exposure light via an organic liquid, and includes:
an oxidation reaction device configured to generate oxide by causing reaction between the organic liquid and at least one of oxygen and water in the organic liquid through the application of illumination light onto the organic liquid; and
a filter configured to remove the oxide generated by the oxidation reaction device from the organic liquid, and
wherein the organic liquid is supplied onto the substrate via the oxidation reaction device and the filter.
